(19) United States
(12) Patent Application Publication
(10) Pub. No.: US 2006/0161636 A1
(43) Pub. Date: Jul. 20, 2006

(54) Method and apparatus for automated discovery of a remote access device address

(75) Inventors: Thomas John Huber, Naperville, IL (US); Michael John Ceruti, Naperville, IL (US); Gary Robert Jenkins, Naperville, IL (US); Daniel E. Bechtlofft, Lemont, IL (US)

Correspondence Address: Dean D. Small;Armstrong Teasdale LLP, Suite 2600, One Metropolitan Square, St. Louis, MO, 63102, US

(73) Assignee: Tellabs Operations, Inc.

(21) Appl. No.: 11/030,454

(22) Filed: Jan. 6, 2005

(51) Int. Cl. G06F 15/16

(52) U.S. Cl. 709/218

(57) ABSTRACT

A method for automatically managing an address of a remote access device (RAD) is disclosed. The method comprises defining the RAD at a service provider, the RAD being located physically remote from the service provider, and assigning a network address to the RAD. The service provider sends a query from a service provider element (SPE) to the RAD requesting the network address.

### BACKGROUND OF THE INVENTION

The invention relates generally to communications systems, and more particularly, to identifying equipment within a communications network.

Methods exist for installing and provisioning new equipment within a communications network. The process of updating data within a network in preparation for use or operation of a network entity is referred to as provisioning. Typically, data is manually updated or provisioned in a network entity through a user interface locally located with the entity. When a piece of equipment or device is added to a communications network, the installer, after installing the equipment in the network, conveys the identity of the newly added equipment to network management personnel. The network management personnel may then update a communications network management system, e.g. an element management system (EMS), with the identity of the new network equipment. An EMS may be provided by the network equipment manufacturer for use by the network operator or service provider to operate and maintain the communications network.

For example, a service provider may utilize a data communications transport network to provide transport services to customers by allowing customer network equipment to interconnect with service provider network equipment. To provide the interconnection, the service provider may install a remote access device (RAD) at the customer premise, for example, an Ethernet access device. The customer network equipment may then connect to the RAD which allows access to the transport network of the service provider. The RAD may be identified to the network by a level-2 and/or level-3 address.

The terms level-2 and level-3 refer to level 2 and level 3 protocol layers defined by the open system interconnection (OSI) model. The model defines a networking framework for implementing communication protocols in seven layers. Within an originating host, control is passed from one layer to the next, starting at the highest layer (e.g. the application layer) and proceeding downwards to the bottom layer (e.g. the physical layer). At the physical layer, the bits of a packet are physically transmitted over a communication channel with the headers and trailers of the packet containing information related to the protocol layers. The packet is received by the terminating host and is processed as the packet proceeds back up the protocol layer hierarchy of the terminating host.

Layer 3, the network layer, provides switching and routing technologies that create logical paths, known as virtual circuits, for transmitting data from one network node to another. Routing and forwarding are functions of this layer, as well as addressing, internetworking, error handling, congestion control, and packet sequencing. A level-3 address (e.g. an Internet protocol (IP) address) is often referred to as the network address, and is used to route the layer 3 packet. At layer 2, the link layer, data packets, often referred to as frames, are encoded and decoded into bits. The media access control (MAC) sublayer and the logical link control (LLC) sublayer are sublayers of the level 2 protocol layer. The MAC sublayer controls how a host station gains access to the data of a frame and permission to transmit the data frame. The LLC sublayer controls frame synchronization, flow control and error checking. A level-2 address (e.g. a MAC address) may be defined in a card or circuit board by the manufacturer. The manufacturer stores the level-2 address in non-dynamic memory of the card. Each card or circuit board manufactured in the world may have a unique level-2 address provided in this way. The RAD may be identified by its level-2 (e.g. MAC) and level-3 (e.g. IP) addresses. The level-2 address may be stored by the manufacturer in non-dynamic RAD memory, and the level-3 address may be assigned to the RAD as discussed herein.

To install and make operational the RAD, a service provider typically performs a number of management steps. Once provided information from the installer, the management personnel of the service provider may use the EMS to activate a management communications channel or port associated with the RAD on an access network switch. The activated management port of the access switch allows communication between the RAD and the access switch, and is herein referred to as the RAD-associated port of the access switch. When the RAD is initialized for operation, data within the RAD designates the management port of the RAD over which the RAD may communicate management information to the access switch. A protocol layer level-2 address of the RAD may be communicated within a level-2 packet, or communications frame, from the RAD to the access switch over the management communications channel. However, the access switch may not be programmed to make use of the level-2 address that is received within the communications frame.

The management channel of the RAD connects to the EMS through the access network switch. One example of an access network switch is a digital cross-connect switch (DCS). Network management personnel may provision a dedicated path through the DCS from the RAD-associated port of the DCS to a data communications network (DCN) port of the DCS. The DCN provides a data network allowing communications between the DCS and the EMS. Once management personnel establish a management channel from the RAD through the access switch to the DCN, management personnel may then update a protocol layer level-3 network address of the RAD within the EMS. For example, a network address of the RAD may be an Internet protocol (IP) address. Management personnel may provision the EMS with the network address of the RAD. The EMS includes the network address of the RAD in management messages directed to the RAD, and sends the messages to the RAD via the DCN. The DCN routes the message, based on the destination network address included within the message, from the EMS to the access switch. A provisioned path through the access switch and through the access network to the RAD provides a path or channel for communicating the message from the access switch to the RAD.

However, the above described procedure has been performed manually by the management personnel. Many issues are associated with the manual procedure described above. A network address may be assigned statically to the RAD, and obtained by the installer when installing the RAD. The installer may incorrectly communicate the correct network address of the RAD to the management personnel. If management personnel enter an incorrect network address for the RAD, the EMS will not be able to communicate with the RAD when the RAD initializes. A second issue pertains to dynamic assignment of a network address to the RAD. Data communications networks may deploy and use a dynamic host configuration protocol (DHCP) server as a central site for administering the network addresses, e.g. IP addresses, assigned to the individual equipment within the network.

Typically, the RAD would initiate a query to the network, to the DHCP server, to obtain a network address. The DHCP server allocates an unused dynamic network address for assignment to the RAD, and informs the RAD via a query response of the dynamic network address assigned to the RAD. The RAD then uses the dynamically assigned network address to communicate with other network switching elements. However, typically the switching elements, and the network, do not inform the EMS of the dynamically assigned RAD network address. From a maintenance point of view, the use of a DHCP server to dynamically allocate and assign network addresses to elements of the network may not be a reconcilable/usable item for the network.

Further improvement is needed in the identification of network equipment of a communications network to the management systems used in managing the network.

### BRIEF DESCRIPTION OF THE INVENTION

In an exemplary embodiment, a method is provided for automatically managing an address of a remote access device (RAD). The method comprises defining the RAD at a service provider, the RAD being located physically remote from the service provider, and assigning a network address to the RAD. The service provider sends a query from a service provider element (SPE) to the RAD requesting the network address.

In another exemplary embodiment, a system is provided for automatically managing an address of a remote access device (RAD). The system includes a service provider RAD located at a customer premise and a service provider element (SPE). The SPE sends a query to the RAD requesting a network address of the RAD. The RAD has a unique network address assigned thereto. A service provider is located at a service provider premise with the service provider premise and the customer premise being physically remote from one another. The system also includes an access network interconnecting the RAD and service provider.

### BRIEF DESCRIPTION OF THE DRAWINGS

FIG. 1 is a general block diagram illustrating a service provider network that includes service provider remote access devices (RADs).

FIG. 2 is a block diagram illustrating the service provider network of FIG. 1 with a focus on communication between the EMS and a RAD.

FIG. 3 is a block diagram illustrating a service provider network formed in accordance with an embodiment of the invention.

FIG. 4 is a flowchart describing an exemplary process within the service provider network in accordance with an embodiment of the invention.

FIG. 5 is a flowchart describing an exemplary fault recovery process in accordance with an embodiment of the invention.

### DETAILED DESCRIPTION OF THE INVENTION

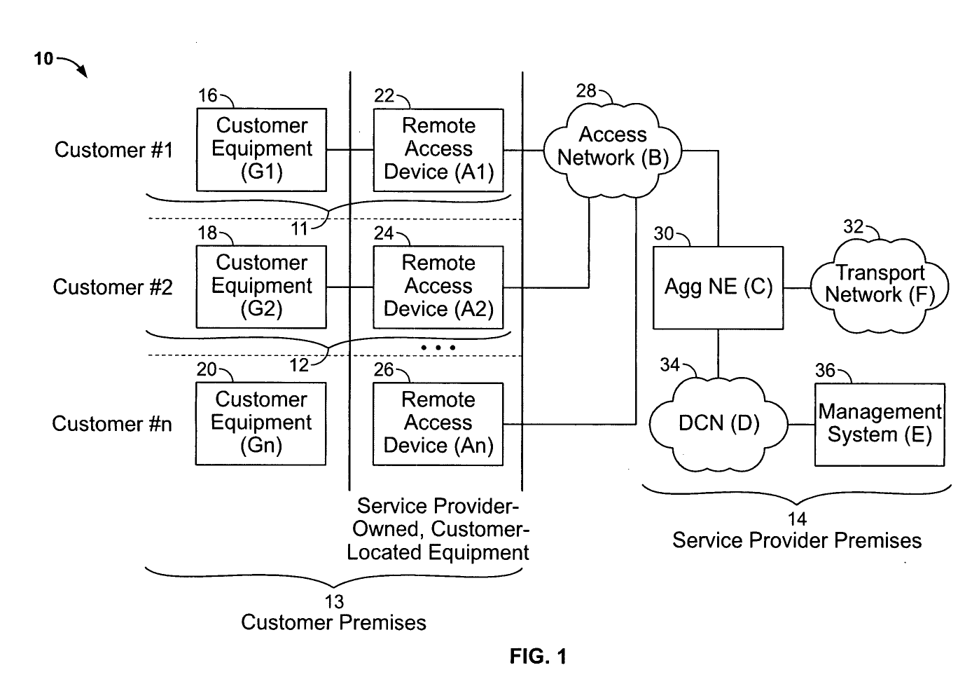

FIG. 1 is a general block diagram illustrating a service provider network 10 having service provider remote access devices (RADs) 22, 24, and 26 that provide access to a service provider access network 28 to obtain the transport services of a service provider transport network 32. A customer #1 has customer equipment 16 connected to the RAD 22 to allow customer #1 access to the transport services. Likewise, customer #2 has customer equipment 18 connected to the RAD 24, and customer #n has customer equipment 20 connected to the RAD 26. The customer equipment 16 and the RAD 22 physically reside at the customer #1 premise 11 (e.g. a business, an office, a home, a portable laptop, etc.). Likewise, the customer equipment 18 and the RAD 24 physically reside at the customer #2 premise 12, and the customer equipment 20 and the RAD 26 physically reside at the customer #n premise 13. One or more of customers #1, #2, and #n may permit more than one end user.

The service provider network 10 also comprises an access network 28, a service provider element (SPE) 30, a transport network 32, a management data communications network (DCN) 34, and an element management system (EMS) 36, all of which physically reside at the service provider premises 14. The service provider premises 14 may represent one physical location or multiple distributed locations. The RADs 22, 24, and 26 are remotely located from the service provider premises 14. By way of example, hundreds of RADs may be remotely located and attached to a single aggregating SPE 30 via the access network 28. The DCN 34 provides the EMS 36 access to the RADs 22, 24, and 26, the access network 28, the SPE 30, and the transport network 32 that transport customer traffic. The EMS 36 allows network management personnel of the service provider to provision, monitor, and maintain the equipment of the service provider network 10.

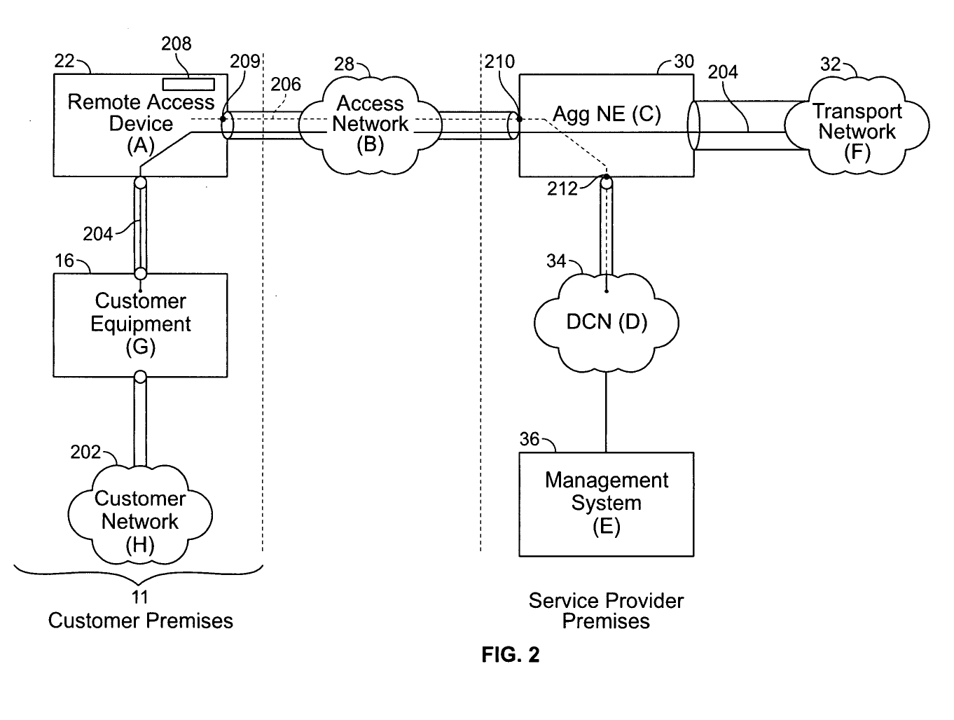

FIG. 2 is a block diagram illustrating the service provider network 10 of FIG. 1 with a focus on communication between the EMS 36 and the RAD 22. In FIG. 2, a customer network 202 allows customer #1 to access the customer equipment 16. The customer network 202 may be a local area network (LAN), e.g. an Ethernet network. The customer equipment 16 accesses the RAD 22, and allows customer #1 to originate user traffic over a traffic channel 204 which extends into the transport network 32.

A series of actions are taken to install the RAD 22 at the customer premise 11 and make the RAD 22 operational within the service provider network 10. An installer deploys the RAD 22 at the customer premise 11, and obtains a network address 208, e.g. an IP address, associated with the RAD 22. The installer notifies the service provider network management personnel of i) the newly deployed RAD 22, ii) the network address 208 assigned to the RAD 22, and iii) a port 210 on the SPE 30 to which the RAD 22 is uniquely associated in a one-to-one relation. The network management personnel define the RAD 22 and the network address 208 within the EMS 36. An access path or management channel 206 is defined through use of the EMS 36 and/or other service provider equipment. Once provisioned, the management channel 206 extends from the RAD 22 through the access network 28 to the port 210, and is cut-through (e.g. is provisioned a path through) the SPE 30 to a port 212 connected to the DCN 34. When RAD 22 initializes, data stored within the RAD 22 designates a management port 209 of the RAD 22 that is connected to the management channel 206. The RAD 22 will use the port 209 to receive and send management messages from and to the EMS 36. Once provisioned with the management channel 206, the SPE 30 uses the provisioned data to identify the port 212 on which the SPE 30 will receive management messages directed to the RAD 22. EMS 36 addresses messages directed to the RAD 22 with the destination address 208, and the DCN 34 routes the messages based on the destination address 208 to the SPE 30 for delivery over the provisioned management channel 206 to the RAD 22.

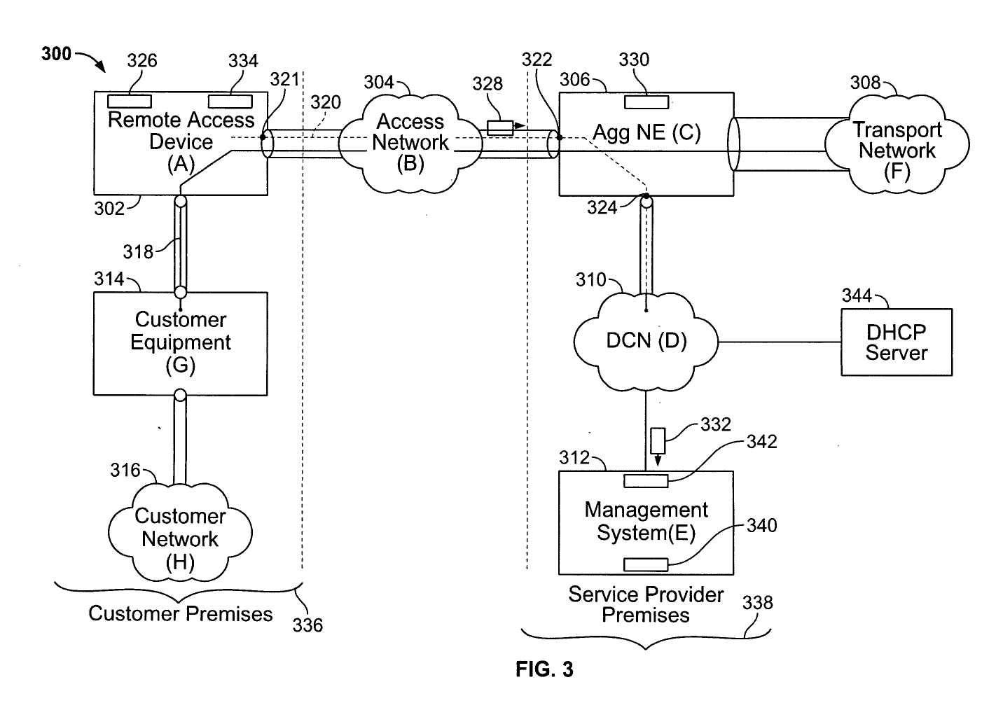

FIG. 3 is a block diagram illustrating a service provider network 300 formed in accordance with an embodiment of the invention. The service provider network 300 includes a remote access device (RAD) 302 providing access to a service provider access network 304 to obtain the transport services of a service provider transport network 308. In FIG. 3, a customer network 316 allows customer users to access customer equipment 314. The customer equipment 314 accesses the RAD 302, and allows users of the customer network 316 to originate user traffic over a traffic channel 318. The traffic channel 318 extends into the transport network 308. The customer equipment 314, the customer network 316, and the RAD 302 physically reside at customer premise 336. The access network 304, a service provider element (SPE) 306, the transport network 308, a data communications network (DCN) 310, and an element management system (EMS) 312 physically reside at service provider premise 338. The service provider premises 338 may represent one physical location or multiple distributed locations. The RAD 302 is located at the customer premise 336, although owned by and part of the service provider network 300. RAD 302 is remotely located from the service provider premise 338.

When initially deployed, the RAD 302 is defined at the service provider network 300, e.g. at the EMS 312. The RAD 302 may be defined at the EMS 312 by provisioning a RAD address table 340 of the EMS 312 with a port 322. The port 322 located at the SPE 306 and a port 321 located at the RAD 302 are connected to each other via a management channel 320. The connection between the port 321 and the port 322 is defined when the access network 304 is provisioned with the management channel 320. Provisioning the port 322 in the RAD address table 340 of the EMS 312 defines the RAD 302 to the service provider network 300 as being part of the network 300. Communications between the EMS 312 and the RAD 302 may occur after deploying the RAD 302, provisioning the management channel 320, defining the RAD 302 to the EMS 312, and initializing the RAD 302.

A static or dynamic network address 326 (e.g. an Internet protocol (IP) address) is provided for the RAD 302. A static network address 326 may be provisioned at the RAD 302. In an alternative embodiment, the RAD 302, during operation, may query a DHCP server 344 to dynamically obtain a network address 326. The DHCP server 344 dynamically allocates the network address 326 for use by the RAD 302 and returns the address 326 in a query response to the RAD 302. The RAD 302 stores the network address 326 for further use.

During operation, the RAD 302 begins sending protocol layer level-2 frames 328 to the SPE 306 over the management channel 320. A level-2 device address 334 associated with the RAD 302 (e.g. a media access control layer (MAC) address) is included in the frames 328. A processing logic 330 within the SPE 306 monitors the incoming frames 328 received from the RAD 302 to obtain the level-2 device address. The processing logic 330 associates the device address 334 with the port 322 on which the RAD 302 is uniquely associated, and stores the association. The processing logic 330 then queries the RAD 302 for the network address 326 that is associated with the device address 334. The RAD 302 sends the network address 326 in a query response to the SPE 306. The processing logic 330 stores the network address 326, and associates the network address 326 and the device address 334 with one another.

Using a port 324 located at the SPE 306 and connected to a data communications network (DCN) 310, the processing logic 330 sends an autonomous message 332 via the DCN 310 to the EMS 312. The autonomous message 332 contains the associated port 322, device address 334, and network address 326. The EMS 312 stores the device address 334 and network address 326 in the RAD address table 340 in association with the provisioned port 322. With the network address 326 for the RAD 302 now defined to the EMS 312, the EMS 312 uses the network address 326 to communicate with the RAD 302 to perform various management applications. Some management applications include the EMS 312 querying the RAD 302 for performance data, the EMS 312 monitoring for alarm messages from/associated with the RAD 302, and configuring/downloading software to the RAD 302 from the EMS 312.

In one embodiment, the port 322 is provisioned in the RAD address table 340 to define the newly installed RAD 302 to the service provider network 300. The EMS 312 periodically queries the SPE 306 based on the port 322 to obtain address information (e.g. the network address 326 and device address 334) related to the port 322. Upon receiving the address information, the EMS 312 stores the address information within the table 340 associated to the port 322. A phantom process 342 may be implemented within the EMS 312 to query the SPE 306 periodically for the address information. The response to the query may be the autonomous message 332 received by the EMS 312 from the SPE 306. The phantom process 342 sleeps/waits for some time interval, and when awakened by receipt of the autonomous message 332 (e.g. the query response) or by a timeout of a timer, checks for and processes the received autonomous message 332. The phantom process 342 then issues a new query to the SPE 306 and returns to sleep.

In another embodiment, the SPE 306, upon receiving RAD address information (e.g. the network address 326 and device address 334 of the RAD 302) in a query response from the RAD 302, may send the autonomous message 332 to the EMS 312 with the RAD address information, whether the EMS 312 has queried the SPE 306 for the information or not.

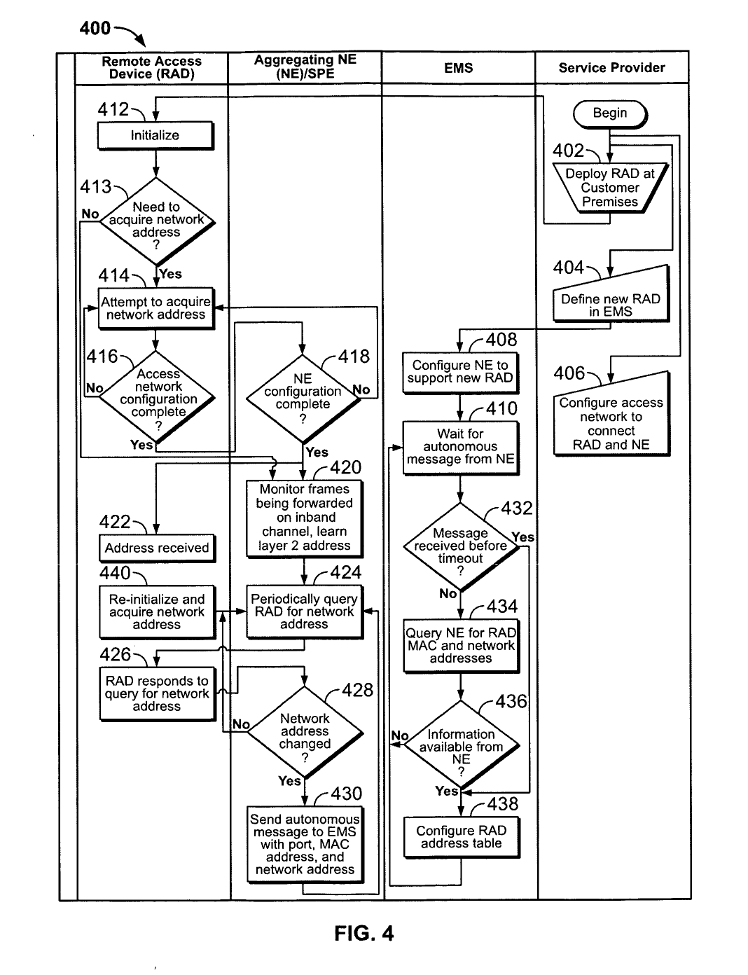

FIG. 4 is a flowchart 400 describing an exemplary process within the service provider network 300 to automatically discover the network address 326 of the RAD 302 within the service provider network 300, and to communicate the discovered network address 326 to the EMS 312. The process of the flowchart 400 is substantially distributed at the RAD 302, the SPE 306, and the EMS 312. At 402, the installer deploys the RAD 302 at the customer premise 336. At 404, the installer informs the service provider management personnel that the RAD 302 is deployed and the management personnel define the new RAD 302 in the EMS 312. This may be done by adding the SPE 306 port 322 that will receive information from the RAD 302 to the RAD address table 340 of the EMS 312. Once the port 322 is defined in the EMS 312, the EMS 312 is able to query the SPE 306 for address information received from the RAD 302.

At 406 and 408, the management personnel configure the access network 304 and the SPE 306 correspondingly, such as through use of the EMS 312, in order to provision the management channel 320. At 410, the EMS 312 waits for receipt of the autonomous message 332 from the SPE 306. The autonomous message 332 conveys the network address 326, the device address 334, and the port 322 associated with the RAD 302. In one embodiment, the wait at 410 may be implemented through the phantom process 342. At 410, the phantom process 342 waits/sleeps until the autonomous message 332 is received in response to a previous query, or until a timer timeout occurs. At 432, the phantom process 342 awakens, and tests for receipt of the autonomous message 332. If no autonomous message 332 has been received, at 434 the phantom process 342 sends a query to the SPE 306 for the address information related to the port 322. During the time of sending the query, the autonomous message 332 may have been received. At 436, the phantom process again tests for whether the autonomous message 332 has been received, or whether the response to the query has been received. If not, the phantom process 342 returns to sleep and waits at 410. If at 432 or 436 an autonomous message 332 has been received, or at 436 a query response has been received, at 438 the phantom process 342 stores the address information from the autonomous message 332 in the RAD address table 340. The phantom process 342 then returns to sleep and waits at 410.

At 412, the RAD 302 initializes. At 413, the RAD 302 determines whether an attempt to acquire a network address is needed. In one embodiment, the RAD 302 through manual provisioning is provided with a static address for the network address 326. No attempt to acquire the network address 326 is needed, and processing proceeds to 420 from 413. In an alternative embodiment, an attempt to acquire the network address 326 is needed. At 414, the RAD 302 attempts to acquire the network address 326 by querying the DHCP server 344. The query may fail at 416 or at 418 due to the management channel not yet being configured, or configured incorrectly, correspondingly in the access network 304 or the SPE 306. If the query fails, processing returns from 416 or 418 to 414 whereat another query is attempted. If the attempted query was successful, at 422 the network address 326 is received in the query response and stored by the RAD 302. Processing continues in the SPE 306 at 420.

At 420, the processing logic 330 of the SPE 306 monitors the port 322 for incoming communications frames 328 from the RAD 302. The processing logic 330 stores the device address 334 received in the incoming frames 328 and associates the device address 334 with the port 322. Once receiving the device address 334, the processing logic 330 at 424 periodically queries the RAD 302 for the network address 326 associated with the device address 334. At 426, the RAD 302 responds to the received query with the network address 326 included in the query response. When receiving the network address 326 in the query response, the processing logic 330 at 428 determines whether the network address 326 has changed from a previous value for the network address 326 that is associated with the port 322. For a first deployment of the RAD 302, the network address value is changed since there is no previous value. During a re-initialization, the RAD 302 may obtain a different value for its network address 326 from the DHCP server 344. Thus, the processing logic 330 may see a change in value for the network address 326 due to a RAD 302 re-initialization. If the processing logic 330 does not detect a change in value for the received network address 326, the processing logic 330 continues to periodically query at 424 the RAD 302 for its network address 326. When detecting a change in value for the network address 326, the processing logic 330 updates the new value and at 430 sends an autonomous message 332 to the EMS 312 over the DCN 310. The autonomous message 332 includes the port address for the port 322 and the associated device address 334 and network address 326. With the network address 326 available to the EMS 312, the EMS 312 is able to communicate with the RAD 302 to perform various management functions.

At 440, a re-initializing of the RAD 302 occurs. The RAD 302 may re-initialize after initial deployment and a first initialization. When re-initializing at 440, the RAD 302 may acquire a different value for the network address 326 from the DHCP server 344. If so, when the SPE 306 queries the RAD 302 at 424 and obtains the new network address 326, a network address change will be detected at 428. At 428, the SPE 306 determines an address change for the network address 326 and at 430 sends an autonomous message 332 to the EMS 312. The phantom process 342 of the EMS 312 discovers at 432 or 436 the receipt of the message 332, and the EMS 312 configures/updates at 438 the RAD address table 340 with the new network address 326. This portion of FIG. 4 exemplifies discovery benefits available during fault recovery wherein the RAD 302 reinitializes (for example due to power outage at the customer premises 336). The discovery benefits exemplified may avoid a management outage wherein the EMS 312 continues to communicate to an old network address 326 without knowing the network address 326 has changed in the RAD 302.

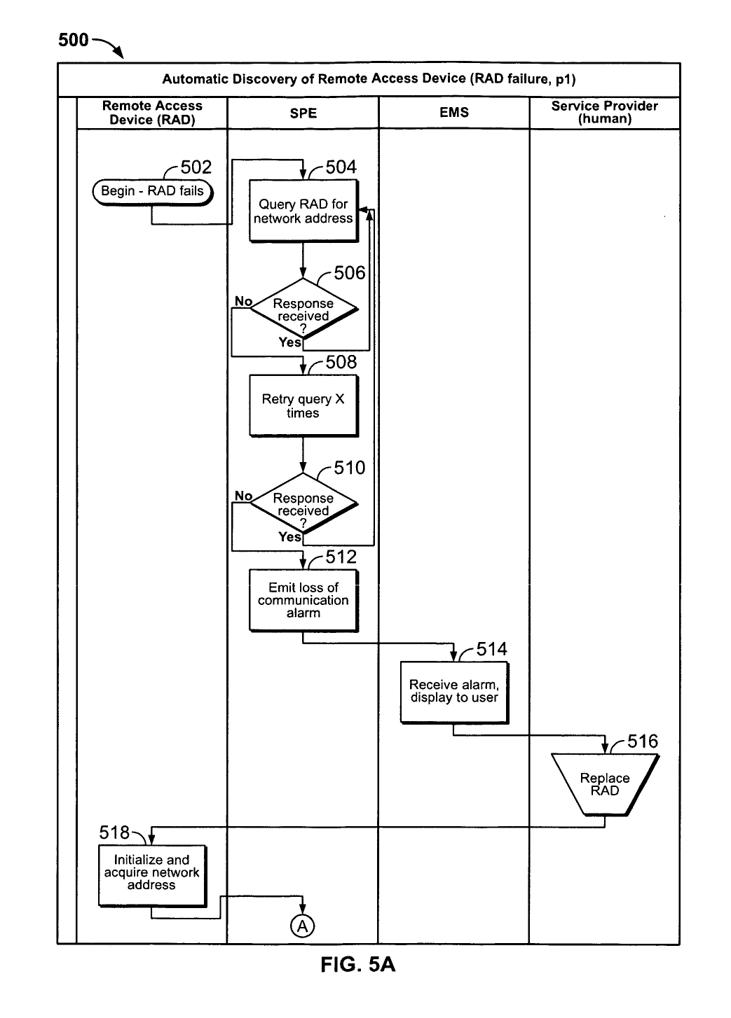

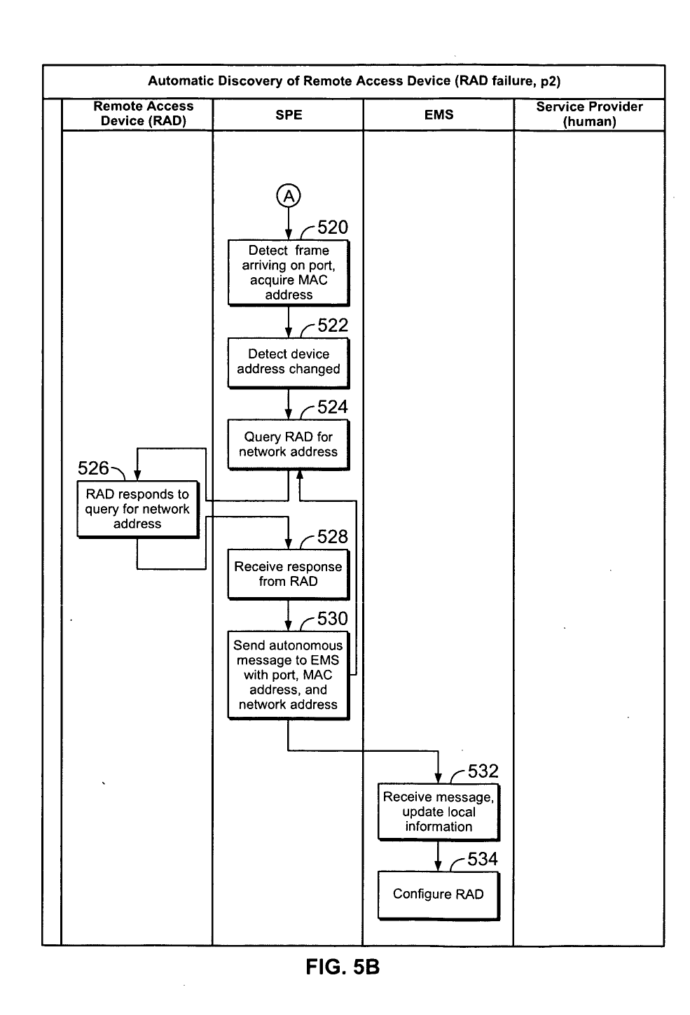

FIG. 5 is a flowchart 500 describing an exemplary process related to the process of FIG. 4. FIG. 5 exemplifies discovery benefits available during a fault recovery wherein the RAD 302 fails and is replaced. The discovery benefits exemplified may avoid a management outage wherein the EMS 312 continues to communicate to an old network address 326 without knowing the network address 326 has changed in the RAD 302. FIG. 5 processing begins with the RAD 302 failing at 502. At 504, similar to 424 in FIG. 4, the SPE 306 queries the RAD 302 for the network address 326. At 506, the SPE 306 determines that no query response is received, and the SPE 306 at 508 resends the query a predetermined number of times. At 510, the SPE 306 determines that no query response has been received for any of the previous predetermined number of query attempts, and SPE 306 at 512 emits/sends a loss of communication alarm to the EMS 312.

At 514, the EMS 312 receives the alarm and displays the alarm to the EMS 312 user. A service provider management personnel travels to the remote customer premise 336 where the RAD 302 is located, and at 516, replaces the RAD 302 (e.g. replaces a RAD board within the RAD 302 unit). At 518, the new RAD 302 re-initializes and acquires a new network address 326, similar to the processing at 440. At 520, the SPE 306 detects a frame 328 arriving on the port 322 and at 522 detects a change in the device address 334 obtained from the frame 328. At 524, the SPE 306 queries for the network address 326 associated with the changed device address 334, and the RAD 302 responds at 526 with the associated network address 326 in the query response. At 528, the SPE 306 receives the query response from the RAD 302 and at 530 sends an autonomous message 332 to the EMS 312. At 532, the EMS 312 receives the message 332. At 534, the EMS 312 configures/updates the RAD address table 340 with the device address 334 and the network address 326. FIG. 5 exemplifies error leg processing wherein the device address 334 of the RAD 302 has changed, or wherein both the device address 334 and the network address 326 of the RAD 302 have changed.

In an embodiment of the invention, the aggregate SPE 306 may be a digital cross-connect switch (DCS). A DCS has paths provisioned in the DCS fabric for routing the traffic. Alternatively, the SPE 306 may be some other variety of network switch, for example one that dynamically allocates paths for the traffic based on the traffic addresses.

In another embodiment, the level-2 device address 334 is a MAC address and the level-3 network address is an IP address. Although other level-2 and level-3 addresses exist for networking protocols, the MAC and IP addresses are typical for data communication networks.

In yet another embodiment, the SPE 306 uses a standard protocol to query the RAD 302 for the network address 326. Two examples of standard protocols that may be used for sending the query to the RAD 302 are Internet control message protocol (ICMP) and reverse address resolution protocol (RARP).

The technical effect of the process described by the flowchart 400 is to automatically discover the network address 326 of the RAD 302, and to provide the discovered network address to the EMS 312.

While the invention has been described in terms of various specific embodiments, those skilled in the art will recognize that the invention can be practiced with modification within the spirit and scope of the claims.

What is claimed is:

1. A method for automatically managing an address of a remote access device (RAD), comprising:
defining the RAD at a service provider, the RAD being located physically remote from the service provider;
assigning a network address to the RAD;
receiving at the service provider, a communication from the RAD; and
sending a query from the service provider to the RAD requesting the network address.

2. The method of claim 1, further comprising:
detecting, at the service provider, a communications frame within the communication from the RAD; and
acquiring a device address of the RAD from the communications frame, the device address being used to send the query.

3. The method of claim 1, further comprising:
detecting, at the service provider, a communications frame within the communication from the RAD; and
sending the query from the service provider to the RAD requesting the network address based on the communications frame.

4. The method of claim 1, further comprising assigning to the RAD first and second addresses associated with different protocol layers, the network address constituting the second address.

5. The method of claim 1, further comprising interconnecting the RAD and the service provider over an access network.

6. The method of claim 1, further comprising locating the RAD at a customer premise and locating the service provider at a service provider premise, the customer and service provider premises being interconnected by an access network.

7. The method of claim 1, further comprising providing a service provider element (SPE) at the service provider, the SPE sending the query from the service provider to the RAD requesting the network address.

8. The method of claim 1, further comprising interconnecting the RAD with a digital cross-connect switch (DCS) located at the service provider, the DCS initiating the query from the service provider to the RAD requesting the network address.

9. The method of claim 1, further comprising providing at the service provider an element management system (EMS), the EMS updating a RAD address table at the service provider based on the network address received from the RAD.

10. The method of claim 1, further comprising transmitting from the RAD to the service provider the network address assigned to the RAD upon receiving the query at the RAD.

11. The method of claim 1, further comprising, in response to the query, determining whether the network address of the RAD has changed, and updating a RAD address table at the service provider with the changed RAD network address when the RAD network address changes.

12. The method of claim 1, wherein said sending a query is automatically repeated at a predetermined interval.

13. The method of claim 1, further comprising:
determining whether a response to the query is received from the RAD; and
identifying a communications failure when no response is received in connection with the query.

14. A system for automatically managing an address of a remote access device (RAD), comprising:
a RAD located at a customer premise;
a service provider element (SPE), the SPE sending a query to the RAD requesting a network address of the RAD, the RAD having a unique network address assigned thereto;
a service provider located at a service provider premise, the service provider premise and the customer premise being physically remote from one another; and
an access network interconnecting the RAD and service provider.

15. The system of claim 14, wherein the SPE monitors communications over the access network from the RAD, the SPE sending the query to the RAD based upon information within the communications received from the RAD.

16. The system of claim 14, wherein the SPE receives a response to the query and sends an autonomous message to an element management system (EMS), the EMS updating a RAD address table with the network address of the RAD obtained from the autonomous message.

17. The system of claim 14, further comprising an element management system (EMS), the EMS sending a query to the SPE requesting the network address of the RAD, the SPE responding to the query from the EMS with a query response containing an autonomous message conveying the network address of the RAD.

18. The system of claim 14, wherein the RAD interconnects the access network and a customer network.

19. The system of claim 14, wherein the RAD is defined at an element management system (EMS) of the service provider by updating a RAD address table.

20. The system of claim 14, wherein the SPE sends an autonomous message to an element management system (EMS) via a data communications network (DCN).

21. The system of claim 14, wherein the RAD is an Ethernet access device.
